(19) United States
(12) Patent Application Publication
(10) Pub. No.: US 2002/0188548 A1
(43) Pub. Date: Dec. 12, 2002

(54) Methods and systems for monitoring securities quotes

(76) Inventor: John Bunda, Austin, TX (US)

Correspondence Address: Eric B. Meyertons, CONLEY, ROSE & TAYON, P.C., P.O. Box 398, Austin, TX, 78767-0398, US

(21) Appl. No.: 09/876,270

(22) Filed: Jun. 6, 2001

(51) Int. Cl. G06F 17/60

(52) U.S. Cl. 705/37

(57) ABSTRACT

Methods and systems for displaying information related to securities are provided. In one embodiment, a method may include receiving quotes for at least one security. The received quotes may include a market center identification, a price, a quantity, and a trading direction. The method may also include combining at least two of the received quotes. The two combined quotes may include quotes received from a common market center. Alternately, the two combined quotes may include quotes received from different market centers. The quotes may be combined if they include a common price and a common trading direction for at least the one security. In addition, the method may include displaying the combined quotes to the user.

### BACKGROUND OF THE INVENTION

1. Field of the Invention

The present invention generally relates to computer software. Certain embodiments relate to computer-implemented methods for monitoring securities quotes (e.g., quotes for stocks, options contracts, futures, bonds, mutual funds, and other investments).

2. Description of the Related Art

The securities trading industry has burgeoned since the advent of the Internet. Many companies offer securities trading services through a variety of automated systems, such as a telephone or a computer system. For example, placing orders to buy or sell securities may include using an order entry screen on a computer system. Before placing an order, a trader of securities may review technical analysis data and/or securities quotes which may aid in making trading decisions.

A stock exchange (or stock market) may facilitate trading in securities by communicating open quotes and orders. A stock exchange may also use market centers to match buyers and sellers of a security. For example, the NASDAQ Stock Market uses the Small Order Exchange System (“SOES”) and Electronic Communication Networks (“ECN”s). Both the SOES and ECNs may be referred to generally as market centers. An ECN may generally refer to an order matching system that may allow traders to advertise a price that may be better than the best (i.e., highest) current bid price or best (i.e., lowest) current ask price for a security. In order to list a price through an ECN, a trader must place a limit order. If a limit order placed through an ECN meets certain criteria, the order may be advertised in the ECN's order book. An order book may be communicated to a stock exchange electronically.

Market makers participating in a market commit capital to buy and sell stock on the market. Under the rules of certain markets (e.g., the NASDAQ Stock Market), a market maker participating in the exchange of a particular security is expected to provide both buy and sell quotes for that security. These quotes do not necessarily represent actual orders; rather they represent a willingness on the part of the market maker to execute transactions at the quoted price. The SOES network is a non-negotiated exchange in which market makers may place offers and bids and may be required to meet fill requirements set forth in a participation agreement with the National Association of Securities Dealers (“NASD”). SOES is directed to filling small orders (i.e., less than 1000 shares). Since SOES is non-negotiated, it may be desirable for certain traders in securities to bypass SOES in favor of negotiating a transaction with an ECN which is better than the current best bid or ask price.

By using an ECN, traders may bypass the SOES network and thus may make markets by playing or splitting the spread. Since SOES is a non-negotiated market, this option is not available to traders through SOES. Examples of ECNs may include Arcapelago (“ARCA”), Bloomberg (“BTRD”), Instinet (“INCA”), Island (“ISLD”), Spear Leeds (“REDI”), and SelectNet (“NASD”).

To facilitate trading, a market generally provides traders with open quote and order information. To make market center quotes and order information more useful in time-critical situations (e.g., day-trading), it may be desirable to provide a method for presenting aggregated trading data in real-time. Moreover, given the quantity of information potentially available to traders, it may also be desirable to provide a method for allowing a trader of securities to customize a display of this data in real-time.

### SUMMARY OF THE INVENTION

An embodiment of the invention relates to an improved computer-implemented method and system for displaying information related to securities to a user. In one embodiment, a system and a method may provide a trader of securities real-time access to combinations of quotes for a security, which may be sorted by common price and common trading direction.

Embodiments described herein may interact with other securities trading systems and methods. For example, embodiments described herein may interact with systems and methods described in co-pending U.S. patent application Ser. No. 09/460,045 which is incorporated by reference as if full set forth herein.

In an embodiment, the method may include receiving quotes for at least one security. The received quotes may include a market center identification, a price, a quantity, and a trading direction. The market center may, for example, include an ECN or SOES. The price may include a bid price. In this manner, the trading direction may be a solicitation to buy at least the one security. Alternatively, the price may include an ask price, and the trading direction may include a solicitation to sell at least the one security. The quantity may include a number of shares. The number of shares may be expressed in terms of some multiple such as hundreds of shares. The received quotes may include additional information such as a date and a time at which the quote was received. More than one quote may be received from each market center. For example, several quotes from different market makers may be received from the SOES market center.

In an embodiment, the method may include combining at least two of the received quotes from the same market center. In another embodiment, the method may include combining two or more quotes received from different market centers. The quotes may be combined if the two or more quotes have a common price and a common trading direction for at least the one security. In addition, at least the two received quotes may be combined automatically.

In an embodiment, the method may include displaying the combined quotes to the user. Displaying the combined quotes may be done in real-time. Alternatively, displaying the combined quotes to the user may be done within a period of time, such as thirty minutes, of receiving a quote from a second or subsequent market center for the common price and the common trading direction for at least the one security. In addition, the combined quotes may be combined automatically.

In an additional embodiment, the method may include receiving user configuration data. The user configuration data may alter the display of the combined quotes to the user. For example, the user configuration data may include a list of columns of quote information to be displayed to the user. The quote information may include, but is not limited to a market center identification, a bid price, an ask price, a quantity, a quote date, a quote time, or a combination thereof.

In a further embodiment, receiving quotes may include receiving quotes in a first computer system. Displaying the combined quotes may include displaying the combined quotes on the first computer system. Alternatively, displaying the combined quotes may include displaying the combined quotes on a second computer system. The second computer may be coupled to the first computer system over a computer network such as the Internet.

In an embodiment, the method may also include receiving user preferences. The user preferences may include a ranking of market centers. For example, the ranking may include a sequence in which the user prefers a trade to be filled by the market centers. In addition, the method may include storing the user preferences. The user preferences may be stored in a memory coupled to a first computer system or a second computer system. The first and second computer system may be configured as described in the above embodiments. The first computer system may be coupled to the second computer system over a computer network.

In an embodiment, the method may further include receiving an order from a user for at least the one security. The received order may include a price. Furthermore, the method may include matching market centers of the combined quotes with market centers in the user preferences according to a sequence in which the user prefers a trade to be filled by the market centers. At least one of the combined quotes may include a price equal to the price of the received order. Market centers of the combined quotes and market centers in the user preferences may be matched automatically. In addition, matching market centers may include automatically matching the market centers in real-time. Alternatively, matching the market centers may include automatically matching the market center within a time period such as thirty minutes of receiving the order.

An additional embodiment may relate to a system configured to display securities information. The system may include a first computer system coupled to a network. The first computer system may include a memory configured to receive user configuration data from a user. The first computer system may also include a display system configured to display securities information in a security display format. The user configuration data may affect the security display format. In addition, the first computer system may be configured to receive securities information from the network and to display securities information in the securities display format. Alternatively, a second computer system may be configured to receive securities information from the network and to display securities information in the securities display format. The securities information may be aggregated. The first computer system or the second computer system may also be configured to receive order placement information for securities from the user.

A further embodiment may relate to a carrier medium which may store program instructions. For example, the carrier medium may include a memory medium. The program instructions may be computer-executable to implement a method for displaying information related to securities. The method may include receiving quotes for at least one security. The method may also include transmitting the quotes to a user interface. In addition, the method may include combining quotes from two or more market centers. The two or more market centers may quote a common price for a common trading direction for at least the one security. The method may further include displaying the combined quotes on the user interface. Furthermore, the method may include receiving order placement information for securities from the user interface.

### BRIEF DESCRIPTION OF THE DRAWINGS

FIG. 1 depicts a schematic diagram of an embodiment of a wide area network suitable for implementing various embodiments;

FIG. 2 depicts an illustration of an embodiment of a computer system suitable for implementing various embodiments;

FIG. 3 depicts a flowchart illustrating a method for displaying security quote information in real-time and for combining security quote information for common quotes in real-time according to one embodiment;

FIG. 4 depicts a flowchart illustrating a method for placing securities orders and for automatically matching placed orders with a quote which may be displayed as shown in FIG. 3 according to one embodiment;

FIG. 5a depicts a related art illustration of a series of bid prices for a security;

FIG. 5b depicts an illustration of a combined series of bid prices for the security as shown in FIG. 5a according to one embodiment; and

FIG. 6 depicts an illustration of a combined series of bid prices and ask prices for the security as shown in FIG. 5a according to one embodiment; and

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Embodiments disclosed herein generally relate to methods and systems for displaying information related to securities to a user. As used herein, a “security” may generally refer to an investment instrument issued by a corporation, government, or other organization which may constitute evidence of debt or equity (e.g., stocks, options contracts, futures, bonds, mutual funds, and other investments). As used herein, “technical analysis” may generally refer to a method for evaluating securities by relying on an assumption that market data (e.g., charts of price, volume, and open interest) may aid in predicting future (usually relatively short-term) market trends. As used herein, a “quote” refers to a willingness to buy or sell a specified number of shares of a security at a specified price. A willingness to buy a security specifies a bid price. As used herein, a “bid price” may generally refer to the price that a buyer may be willing to pay for a security at a specified time. Conversely, a willingness to sell specifies an ask price. As used herein, an “ask price” may generally refer to the price that a seller may be willing to accept for a security at a specified time. As used herein, a “trade price” or “price” of a security may generally refer to a price of a transaction for the security.

As used herein, an “order” is a request to buy or sell a specified number of shares of a security. An order which specifies a price is called a “limit order.” An order which does not specify a price is called a “market order.” A market order may be executed at the best price currently available on the market. As used herein, the “spread” may generally refer to the difference between the best (i.e., highest) current bid price and the best (i.e., lowest) current ask price for a security. For example, the best (i.e., highest) current bid price for a security may be 92.25, and the best (i.e., lowest) current ask price for the security may be 92.75. Therefore, the spread between the bid price and the ask price may be 0.5 points (i.e., the difference between 92.75 and 92.25 is 0.5: a “point” is $1, thus a 0.5 points is $0.50). For example, through an ECN a trader may advertise a better bid price of 92.5 by placing a limit order at that price. An order may also specify a trading direction. As used herein, a “trading direction” may generally refer to either a willingness to buy a security or a willingness to sell the security. When the trading direction is a willingness to buy, the price is referred to as a bid price. Conversely, when the trading direction is a willingness to sell, the price is referred to as an ask price.

As used herein, an “ECN” may generally refer to a market center which includes an order matching system that may allow traders to advertise a price that may be better than the best (i.e., highest) current bid price or best (i.e., lowest) current ask price for a security. As used herein, an “order book” may generally refer to a listing of open orders available through a market center. As used herein, a “market maker” may generally refer to an entity (e.g., a brokerage, a bank) that maintains an orderly market in a security by standing ready, willing, and able to buy and sell the security. As used herein, a “market center” may refer to a network or system which facilitates trading in securities. For example, an ECN may be considered a market center. The SOES network may be considered a market center.

As used herein, “real-time” may generally refer to a response to stimuli within some relatively small upper limit of response time (e.g., seconds or minutes). As used herein, “automatically” may generally refer to an action taken without requiring manual steps on the part of the user.

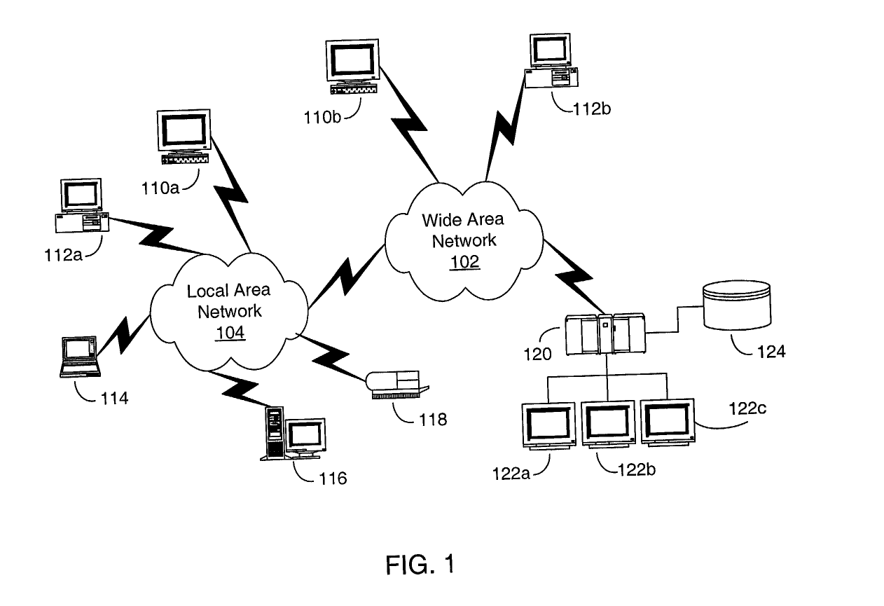

FIG. 1 illustrates a wide area network (WAN) according to one embodiment. WAN 102 may be a network that spans a relatively large geographical area. The Internet is an example of a WAN. WAN 102 may typically include a plurality of computer systems which may be interconnected through one or more networks. Although one embodiment is shown in FIG. 1, WAN 102 may include a variety of heterogeneous computer systems and networks which may be interconnected in a variety of ways and which may run a variety of software applications.

One or more local area networks (LANs) 104 may be coupled to WAN 102. A LAN may be a network that spans a relatively small area. For example, a LAN may be confined to a single building or a group of buildings. Each node (i.e., individual computer system or device) on LAN 104 may preferably have its own CPU with which it may execute programs. In addition, each node may also be able to access data and devices anywhere on LAN 104. LAN 104 may thus allow many users to share devices (e.g., printers) as well as data stored on file servers. LAN 104 may be characterized by any of a variety of types of topology (i.e., a geometric arrangement of devices on the network), of protocols (i.e., rules and encoding specifications for sending data, and whether the network uses a peer-to-peer or client/server architecture), and of media (e.g., twisted-pair wire, coaxial cables, fiber optic cables, or radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, LAN 104 may include one of each of computer systems 110a, 112a, 114, and 116, and one printer 118. LAN 104 may be coupled to other computer systems and/or other devices and/or other LANs 104 through WAN 102.

One or more mainframe computer systems may be coupled to WAN 102. As shown, mainframe computer system 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120.

WAN 102 may also include computer systems, which are connected to WAN 102 individually and not through a LAN 104 such as workstation 110b and personal computer 112b. For example, WAN 102 may include computer systems which may be geographically remote and connected to each other through the Internet.

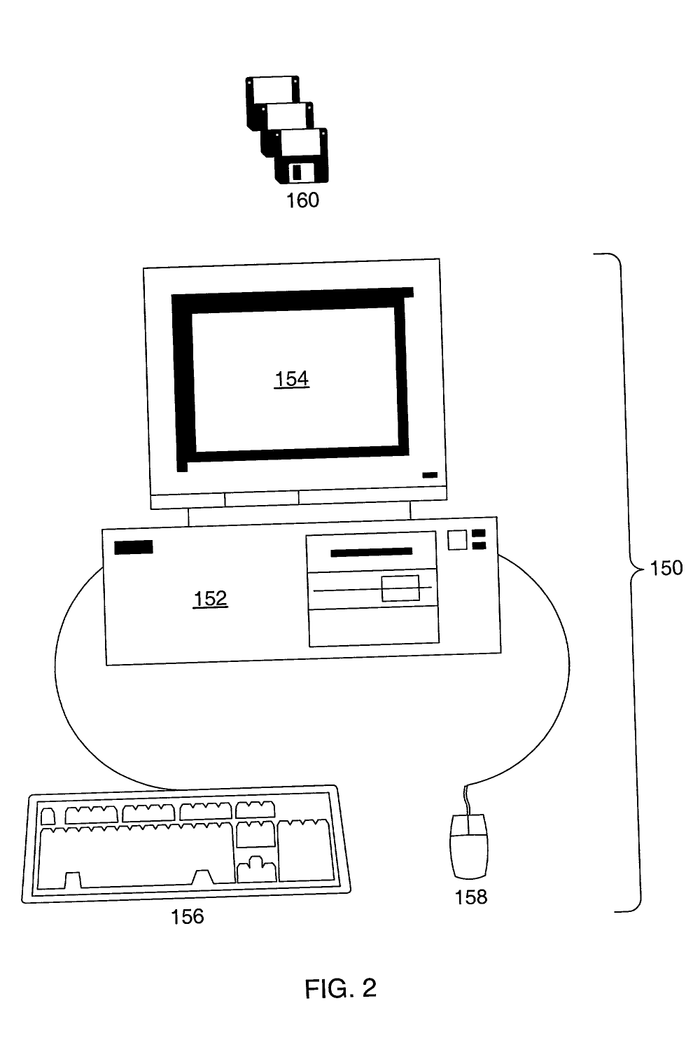

FIG. 2 illustrates an embodiment of computer system 150 which may be suitable for implementing various embodiments of a system and a method for displaying information related to securities to a user. Computer system 150 may typically include components such as CPU 152 with an associated memory medium such as floppy disks 160. The memory medium may be configured to store program instructions for computer programs. The program instructions may be executable by CPU 152. Computer system 150 may further include a display device such as monitor 154, an alphanumeric input device such as keyboard 156, and a directional input device such as mouse 158. Computer system 150 may be operable to execute the computer programs to implement a method for displaying information related to securities to a user as described herein.

Computer system 150 may preferably include a memory medium on which computer programs according to various embodiments disclosed herein may be stored. The term “memory medium” may generally refer to an installation medium, e.g., a CD-ROM, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs may be executed. Alternatively, the memory medium may be located in a second different computer which may connect to the first computer over a network. In the latter instance, the second computer may provide program instructions to the first computer for execution. In addition, computer system 150 may take various forms such as a personal computer system, mainframe computer system, workstation, network appliance, Internet appliance, personal digital assistant (PDA), television system or other device. In general, the term “computer system” may be broadly defined to encompass any device having a processor which may execute instructions from a memory medium.

The memory medium may preferably store a software program or programs for displaying information related to securities to a user as described herein. The software program(s) may be implemented in any of various ways such as procedure-based techniques, component-based techniques, and/or object-oriented techniques, among others. For example, the software program(s) may be implemented using ActiveX controls, C++ objects, JavaBeans, Microsoft Foundation Classes (MFC), browser-based applications (e.g., Java applets), traditional programs, or other technologies or methodologies, as desired. A CPU, such as host CPU 152, executing instructions from the memory medium may include a means for creating and executing the software program or programs according to the methods described below.

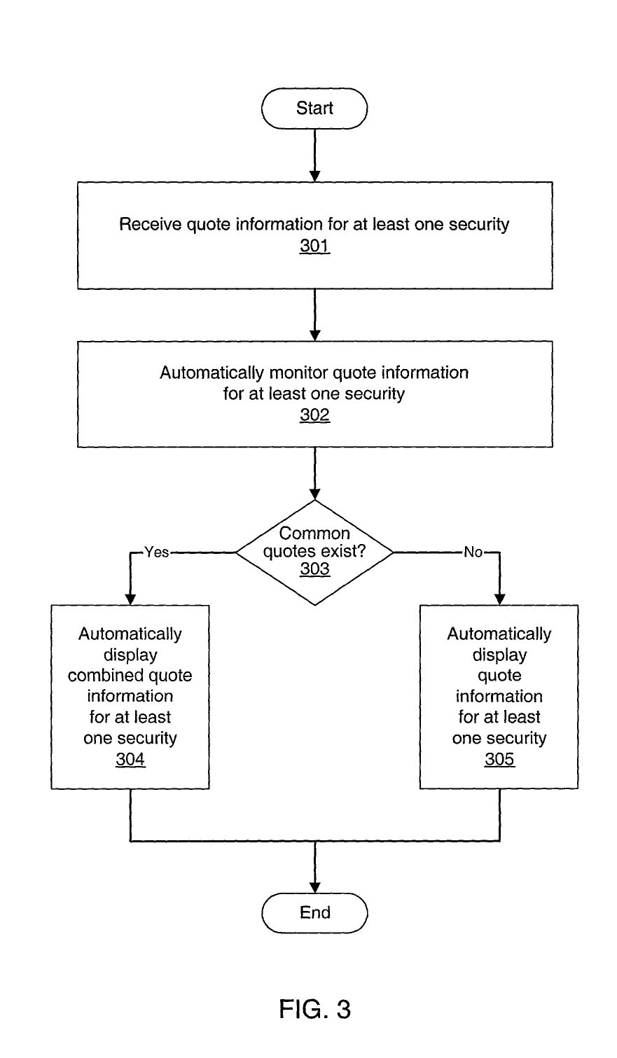

FIG. 3 is a flowchart illustrating an embodiment of a method for displaying security quote information in real-time and combining security quote information for common quotes in real-time.

In step 301, security quote information may be received into a first computer system for at least one security. Examples of types of information that may be received in a security quote may include a market center identification, a price, a quantity (e.g., a number of shares), and a trading direction for a given security. The quantity may represent a number of shares directly or indirectly as a number expressed in terms of some multiple of shares (e.g., hundreds of shares). For example, if the quantity is “10”, then the quantity may represent 10 shares or 1,000 shares (i.e., 10*100 shares). Typically, the quantity represents the same multiple (e.g., 1, 10, 100) for all securities shown in a display at one time. The multiple that the quantity represents may be a userconfigurable value.

In step 302, security quote information for at least the one security may be automatically monitored. As shown in step 303, the method may include determining if a previously received security quote for at least the one security has the same price and the same trading direction as the most recently received security quote for at least the one security. Two or more security quotes received from a market center, which may have a common price and a common trading direction for a security, may be referred to as “common quotes.”

The method may include step 304 if the determination in step 303 is that common quotes exist. In this step, security quote information for the most recently received security quote may be combined with one or more previously received security quotes to form the combined quotes. Subsequent to combining the security quote information, the combined security quote information may be automatically displayed for at least the one security as shown in step 304.

Alternatively, the method may include step 305 if the determination in step 303 is that common quotes do not exist. In this step, security quote information for the most recently received security quote may be automatically displayed for at least the one security.

The combined security quote information and/or the most recently received security quote information may be automatically displayed to a user in real-time or with a time delay. A value for the time delay may be user-configurable. In one embodiment, the user may select a real-time display by inputting a “0” for the time delay value. An increment of the time delay (e.g., minutes, seconds) may also be user-configurable. For example, if the time delay value is “15” and the time delay increment is minutes, the information may be automatically refreshed every 15 minutes. Additionally, the combined security quote information and/or the most recently received security quote information may be automatically displayed on a first computer system or on a second computer system. The second computer system may be coupled to the first computer system over a computer network. The computer network may be the Internet.

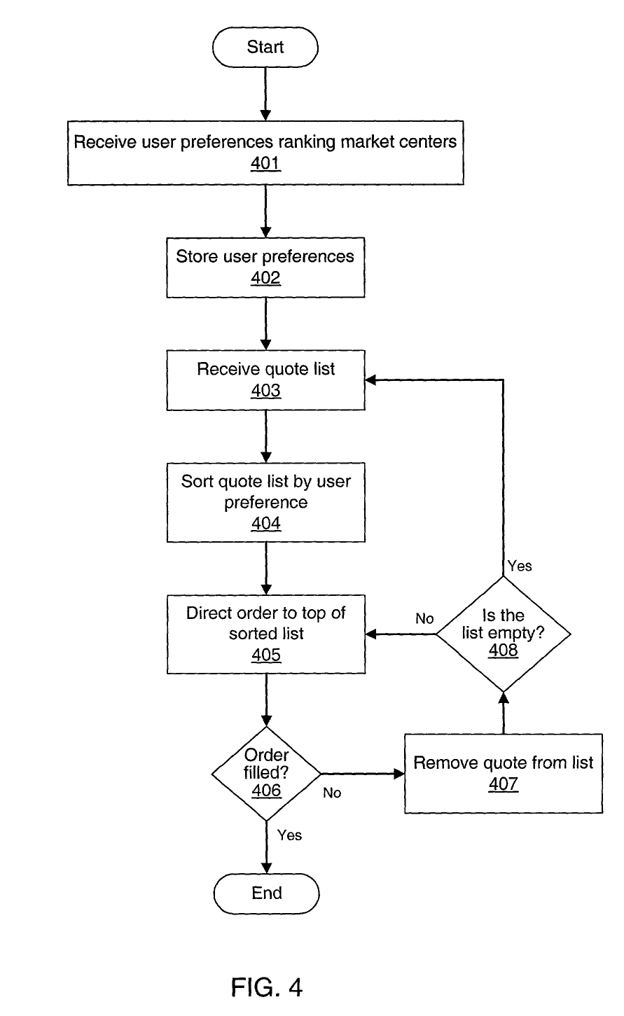

FIG. 4 is a flowchart illustrating an embodiment of a method of order placement for securities that may include automatically matching a placed order with quote information displayed in FIG. 3. Upon review of the securities quote information displayed by the method depicted in FIG. 3, a user may choose to trade a security. Trading may involve using user preferences previously stored in a first computer system or a second computer system, as described below. User preferences may rank market centers according to a sequence in which the user prefers a trade to be filled by the market centers. Upon a user's request to place an order (e.g., a buy order or a sell order for a security displayed with a combined quote), market centers represented in a combined quote may be automatically matched with market centers in the user preferences to fill the order. If an order is not filled by a first market center, the method may include attempting to fill the order though a second market center.

In step 401, user preference information may be received into a first computer system for at least one market center. Multiple market centers entered by a user may be ranked (by the user) such that the ranking may be a sequence in which the user prefers a trade to be filled. In one embodiment, one ranking of market centers may be associated with a security or a group of securities, and other rankings of market centers may be associated with a different security or a different group of securities.

In step 402, the user preference information may be stored in a memory coupled to the first computer system. Alternately, user preference information may be stored in a memory coupled to the second computer system. In step 403, the method may include receiving a list of quotes. Two or more quotes from the received list of quotes may be combined for display to a user as described herein. In step 404 the method may include sorting the received quotes according to the stored user preference information. In some embodiments, the quote list may be sorted both by price, and according to the user preference information.

When a user places an order, the method may include step 405 to direct the order to the first quote in the sorted quote list. In step 406, the method may include determining if the order placed by the user was filled. If the order was filled, then the method may be complete. After the method is complete, it may be initiated again at step 401, 403 or 405. If the order was not filled, the method may include step 407 to remove the quote the order was directed to from the sorted quote list. In step 408, the method may include determining if any quotes remain in the quote list after removing the quote in step 407. If the quote list is empty, the method may return to step 403. If one or more quotes remain in the quote list, the method may return to step 405. The method may continue in this manner until the order is filled, or until there are no quotes available which meet any conditions which may have been specified in the order (e.g., a limit price).

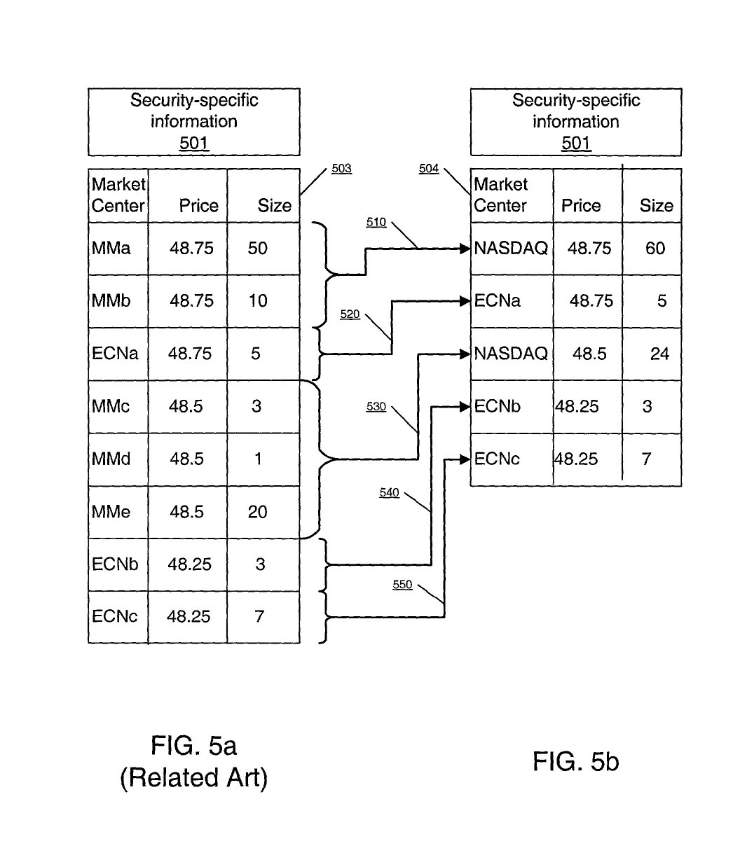

FIG. 5a is a related art illustration of a series of bid prices for a security. The illustration in FIG. 5a may represent a screenshot of a user interface where a series of bid prices for a security are displayed. As shown, security-specific information 501 may be displayed at the top of the screenshot. Security-specific information 501 may include: a security symbol, a tick direction, a company name that corresponds to the security symbol, a type of business (e.g., Communications Equipment, Conglomerates), a previous closing price, a last printed trade price, a net change in price from the previous day's closing price, a highest trade price since opening of the trading session, a highest ask price since opening of the trading session, a last size (i.e., an actual number or a multiple of shares) traded, a current volume being traded, a lowest trade price since opening of the trading session, a lowest bid price since opening of the trading session, “bid×size” (i.e., the largest size bid at the inside quote), “ask×size” (i.e., the largest size ask at the inside quote), gap in price from previous day's closing price to today's opening price, and opening price of the trading session. The “x” in the two terms “bid×size” and “ask×size” represents multiplication (i.e., times). For example, a “bid×size” may be “90×1.” Similarly, an “ask×size” may be “95×1.”

As used herein, a “tick” may generally refer to the smallest change which may occur in a security's price. As used herein, a “tick direction” may generally refer to a direction (e.g., up or down) of change in a security's price as compared to the most recent trade price of the security. As used herein, an “inside quote” may generally refer to a difference between the best bid price and the best ask price quoted by any market center for a security.

Bid prices 503 may be shown below security-specific information 501. Columns of information may be included in bid prices 503 such as market center identification, price, and size. Additional columns may be displayed, based on user preferences. Examples of additional columns may include: a tick direction, a change, a quote date and time, and a quote condition.

FIG. 5b is an illustration of an embodiment of a combined series of bid prices for the security as shown in FIG. 5a. The illustration in FIG. 5b may represent a screenshot of a user interface where a series of bid prices for a security are displayed.

Similar to FIG. 5a, security-specific information 501 may be displayed at the top of the screenshot. Security-specific information 501 may include: a security symbol, a tick direction, a company name that corresponds to the security symbol, a type of business (e.g., Communications Equipment, Conglomerates), a previous closing price, a last printed trade price, a net change in price from the previous day's closing price, a highest trade price since opening of the trading session, a highest ask price since the open of the trading session, a last size (i.e., an actual number or a multiple of shares) traded, a current volume being traded, a lowest trade price since opening of the trading session, a lowest bid price since opening of the trading session, “bid×size” (i.e., the largest size bid at the inside quote), “ask×size” (i.e., the largest size ask at the inside quote), gap in price from previous day's closing price to today's opening price, and opening price of the trading session.

Bid prices 504 may be shown below security-specific information 501. Three columns of information may be included in bid prices 504 such as market center identification, price, and size. Additional columns may be displayed, based on user preferences. Examples of additional columns may include: a tick direction, a change, a quote date and time, and a quote condition.

In one embodiment, as shown in FIG. 5b, the market center column for each row of the combined quote information may include a generic term (e.g., NASDAQ). Also shown in FIG. 5b, the market center column for each row of the quote information representing a quote from a single market center may include an abbreviation for a single market center (e.g., ISLD).

Combining quote information for a common price and from a common market center (e.g., SOES, or ECN) from FIG. 5a into a single combined quote for the common price in FIG. 5b may be illustrated through the use of arrows 510 and 530. As used herein, “MMx,” where x is a letter, represents an individual market maker. As used herein, “ECNx,” where x is a letter, represents an individual ECN. Arrow 510 illustrates combining two quotes (as shown in FIG. 5a) at a common price of 48.75 (i.e., a quote of size 50 from market maker MMa, and a quote of size 10 from market maker MMb) into one combined quote (as shown in FIG. 5b) at the common price of 48.75. The combined quote may be displayed generically with market center NASDAQ and a size of 60 (i.e., 50+10).

Arrow 530 illustrates combining three quotes (as shown in FIG. 5a) at a common price of 48.5 (i.e., a quote of size 3 from market maker MMc, a quote of size 1 from market maker MMd, and a quote of size 20 from market maker MMe) into one combined quote (as shown in FIG. 5b) at the common price of 48.5. The combined quote may be displayed generically with market center NASDAQ and a size of 24 (i.e., 3+1+20).

Arrow 520 illustrates that only one quote from one ECN (i.e., ECNa) exists for the security at a price of 48.75. Therefore, a row of information in FIG. 5b for ECNa matches the corresponding row of information for ECNa as shown in FIG. 5a. The bids from ECNa, and market makers MMa and MMb are from different market centers, but at the same price. Since the market centers are different, the bid from ECNa is not combined with the bids from MMa and MMb.

Arrows 540 and 550 illustrate two quotes from ECNs (as shown in FIG. 5a) at a common price of 48.25 (i.e., a quote of size 3 from ECNb and a quote of size 7 from ECNc). Since the ECNb and ECNc are different market centers, the two quotes are not combined into one combined quote (as shown in FIG. 5b) at the common price of 48.25.

It may be advantageous to combine identical quotes from the same market center in the manner described herein since orders directed to these identical quotes may be expected to be executed in the same manner. In the case of the NASDAQ market, combining identical quotes from the same market center may include combining identical quotes available through the SOES. In this case, the combined identical quotes may be from different market makers. It is believed that by combining quotes in this manner, the amount of data presented to a trader may be minimized without the loss of critical information. However, it is anticipated that the methods and systems of embodiments presented herein may also be used to combine identical quotes from different market centers. Such embodiments may be perceived as advantageous by certain traders as they may further minimize the data presented to the trader.

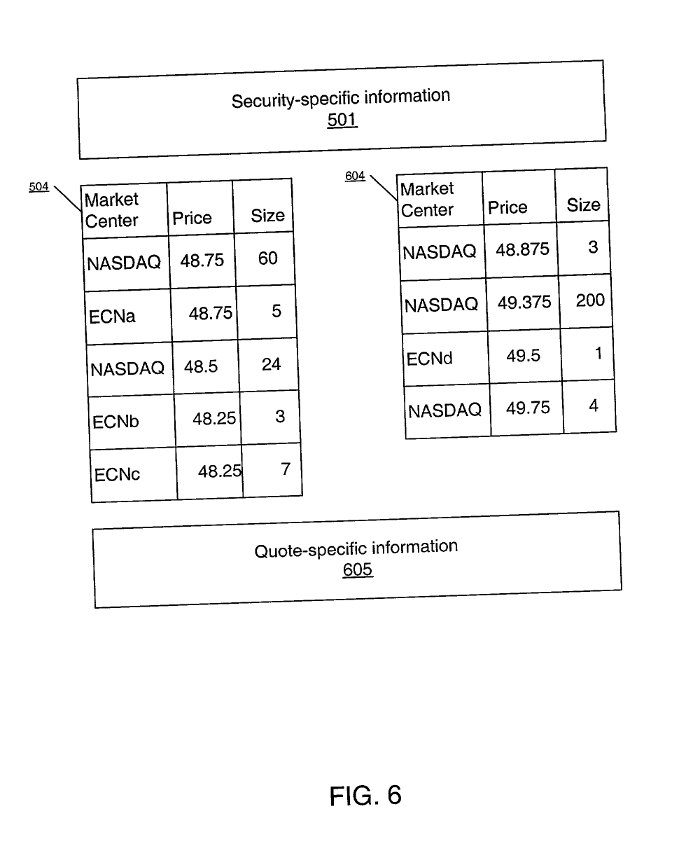

FIG. 6 is an illustration of an embodiment of a combined series of bid prices and ask prices for the security as shown in FIG. 5a. The illustration in FIG. 6 may represent a screenshot of a user interface in which a series of bid prices for a security are displayed on one side (i.e., the left side) of the screenshot, and a series of ask prices for the security are displayed on another side (i.e., the right side) of the screenshot. In one embodiment, positioning of the bid prices and/or the ask prices on the screenshot (e.g., left, right, top, bottom) may be user-configurable.

Similar to FIGS. 5a and 5b, security-specific information 501 may be displayed at the top of the screenshot. The display of security-specific information 501 in FIG. 6 is shown as expanding across bid prices 504 and ask prices 604. In one embodiment, positioning of security-specific information 501 on the screenshot (e.g., top, bottom, expanded, collapsed) may be user-configurable.

As shown in FIG. 6, bid prices 504 match bid prices 504 as shown in FIG. 5b. Ask prices 604 may be shown below security-specific information 501 and to the right of bid prices 504. Columns of information may be shown in the ask prices 604 such as market center identification, price, and size. Additional columns may be displayed based on user preferences. Examples of additional columns may include: a tick direction, a change, a quote date and time, and a quote condition.

In one embodiment, as shown in both bid prices 504 and ask prices 604 of FIG. 6, the market center column for each row of combined quote information may include a generic term (e.g., NASDAQ). Also shown in both bid prices 504 and ask prices 604 of FIG. 6, the market center column for each row of quote information may include an abbreviation for a single market center (e.g., ECNa and ECNd) to represent a quote from the single market center.

Although a figure similar to FIG. 5a including individual market center ask prices is not shown, the method as described regarding FIG. 5b, may be used to create a single row of combined quote information for each ask price for the security. As indicated by the NASDAQ value in the market center column in ask prices 604 of FIG. 6, at least two market center ask quotes may be combined at the common prices of 48.875, 49.375, and 49.75, into one combined quote at each common price-point, respectively (i.e., common price 48.875 has a combined size of 3, common price 49.375 has a combined size of 200, and common price 49.75 has a combined size of 4).

As shown, quote-specific information 605 may be displayed at the bottom of the screenshot. In one embodiment, positioning of quote-specific information 605 on the screenshot (e.g., top, bottom, expanded, collapsed) may be user-configurable.

Quote-specific information may include: a price, a number of shares, a market center identification, a market center identification number, a trailing stop price, a stop loss price, a selection mechanism (e.g., a “purchase” push-button), and an account identification number. Additional (or less) quote-specific information may be displayed based on user configuration settings. As used herein, a “trailing stop order” may generally refer to a stop loss order that may follow a favorable price trend. As used herein, a “trailing stop price” may generally refer to a price specified in a trailing stop order. As used herein, a “stop loss order” may generally refer to an order to buy or sell a quantity of a security if a specified price is reached or passed. For example, the specified price may be below the current market price, and the order may be to sell. As used herein, a “stop loss price” may generally refer to a price specified in a stop loss order.

Quote-specific information 605 may be displayed upon selection of a particular row from either bid prices 504 or ask prices 604 by a user. Fields in quote-specific information 605 may also be pre-filled with values taken from the selected row in either bid prices 504 or ask prices 604. A user may modify fields in quote-specific information 605. When the user determines that the fields in quote-specific information 605 represent an order that the user desires to place, the user may place the order by selecting a selection mechanism (e.g., selecting the “purchase” push-button).

User preferences specifying a ranking of market centers such that the ranking specifies a sequence in which the user prefers an order to be filled by the market centers may be entered in a screen separate from quote-specific information 605. Upon user request to place an order (e.g., a buy order or a sell order for a security displayed with a combined quote), a market center represented in a combined quote may be automatically matched with market centers in the user preferences to fill the order.

Various embodiments further include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, conveyed via a communication medium such as networks 102 and/or 104 (as shown in FIG. 1) and/or a wireless link.

While the specific examples set forth herein are generally directed to embodiments related to the NASDAQ Stock Market, it will be recognized by those skilled in the art that the embodiments disclosed herein may be applied to other stock markets as well.

It will be appreciated to those skilled in the art having the benefit of this disclosure that this invention is believed to provide methods and systems for displaying information related to securities to a user. Further modifications and alternative embodiments of various aspects of the invention will be apparent to those skilled in the art in view of this description. For example, the method and systems may also be used for monitoring quotes in other industries such as on-line auctions. It is intended that the following claims be interpreted to embrace all such modifications and changes and, accordingly, the specification and drawings are to be regarded in an illustrative rather than a restrictive sense.

What is claimed is:

1. A computer-implemented method for displaying information related to securities to a user, comprising:
receiving a plurality of quotes for at least one security, wherein the received quotes comprise an identification of a market center, a price, a quantity, and a trading direction;
combining at least two of the received quotes; and
displaying at least the combined quotes to the user.

2. The method of claim 1, wherein the market center of a portion of the plurality of quotes comprises an electronic communications network, and wherein the market center of another portion of the plurality of quotes comprises a small order exchange system.

3. The method of claim 1, wherein the market center of a portion of the plurality of quotes comprises an electronic communications network, and wherein the market center of another portion of the plurality of quotes comprises a small order exchange system, and wherein the quotes from the electronic communications network are displayed separately from the quotes from the small order exchange system.

4. The method of claim 3, wherein two or more quotes from the small order exchange system are combined for display if the price of the two or more quotes is the same.

5. The method of claim 1, wherein the at least two received quotes combined comprise a common market center, a common price and a common trading direction for at least the one security.

6. The method of claim 1, wherein the at least two received quotes combined comprise different market centers, a common price and a common trading direction for at least the one security.

7. The method of claim 1, wherein the market center comprises an electronic communications network.

8. The method of claim 1, wherein the market center comprises a small order exchange system.

9. The method of claim 1, wherein the price comprises a bid price, and wherein the trading direction comprises a willingness to buy at least the one security.

10. The method of claim 1, wherein the price comprises an ask price, and wherein the trading direction comprises a willingness to sell at least the one security.

11. The method of claim 1, wherein the quantity comprises a number of shares.

12. The method of claim 1, wherein the quantity comprises a number of shares, and wherein the number of shares is expressed in terms of hundreds of shares.

13. The method of claim 1, wherein combining at least two of the received quotes comprises automatically combining at least two of the received quotes.

14. The method of claim 1, wherein displaying the combined quotes comprises automatically displaying the combined quotes to a user in real-time.

15. The method of claim 1, wherein displaying the combined quotes comprises automatically displaying the combined quotes within thirty minutes of receiving an quote from a second or subsequent market center for the common price and the common trading direction for at least the one security.

16. The method of claim 1, wherein receiving quotes comprises receiving quotes in a first computer system, and wherein displaying the combined quotes comprises displaying the combined quotes on the first computer system.

17. The method of claim 1, wherein receiving quotes comprises receiving quotes in a first computer system, wherein displaying the combined quotes comprises displaying the combined quotes on a second computer system, and wherein the second computer system is coupled to the first computer system over a computer network.

18. The method of claim 1, wherein receiving quotes comprises receiving quotes in a first computer system, wherein displaying the combined quotes comprises displaying the combined quotes on a second computer system, wherein the second computer system is coupled to the first computer system over a computer network, and wherein the computer network comprises the Internet.

19. The method of claim 1, wherein the received quotes further comprise a date and time at which the quote was received.

20. The method of claim 1, further comprising receiving user configuration data, wherein the user configuration data is used to alter the display of the combined quotes to the user.

21. The method of claim 1, further comprising receiving user configuration data, wherein the user configuration data is used to alter the display of the combined quotes to the user, and wherein the user configuration data comprises a list of columns of quote information to be displayed.

22. The method of claim 1, further comprising receiving user preferences, wherein the user preferences comprise a ranking of market centers, and wherein the ranking comprises a sequence in which the user prefers a trade to be filled by the market centers.

23. A computer-implemented method for trading securities, comprising:
receiving a plurality of quotes for at least one security, wherein the received quotes comprise an identification of a market center, a price, a quantity, and a trading direction;
combining at least two of the received quotes;
displaying the combined quotes to the user; and
receiving an order from a user for at least the one security.

24. The method of claim 23, wherein the market center of a portion of the plurality of quotes comprises an electronic communications network, and wherein the market center of another portion of the plurality of quotes comprises a small order exchange system.

25. The method of claim 23, wherein the market center of a portion of the plurality of quotes comprises an electronic communications network, and wherein the market center of another portion of the plurality of quotes comprises a small order exchange system, and wherein the quotes from the electronic communications network are displayed separately from the quotes from the small order exchange system.

26. The method of claim 24, wherein two or more quotes from the small order exchange system are combined for display if the price of the two or more quotes is the same.

27. The method of claim 23, wherein the at least two received quotes combined comprise a common market center, a common price and a common trading direction for at least the one security.

28. The method of claim 23, wherein the at least two received quotes combined comprise a different market center, a common price and a common trading direction for at least the one security.

29. The method of claim 23, further comprising receiving user preferences.

30. The method of claim 29, wherein the user preferences comprise a ranking of market centers, and wherein the ranking comprises a sequence in which the user prefers a trade to be filled by the market centers.

31. The method of claim 29, further comprising storing the user preferences.

32. The method of claim 29, further comprising matching market centers of the combined quotes with market centers in the user preferences according to a sequence the user prefers a trade to be filled by the market centers, wherein at least one of the combined quotes comprises a price equal to the price of the received order.

33. The method of claim 32, wherein matching market centers comprises automatically matching the market centers in real-time.

34. The method of claim 32, wherein matching market centers comprises automatically matching the market centers within thirty minutes of receiving the order.

35. The method of claim 23, wherein the received order comprises a price.

36. The method of claim 23, wherein the market center comprises an electronic communications network.

37. The method of claim 23, wherein the market center comprises a small order exchange system.

38. The method of claim 23, wherein the quantity comprises a number of shares.

39. The method of claim 23, wherein the quantity comprises a number of shares, and wherein the number of shares is expressed in hundreds of shares.

40. The method of claim 23, wherein combining at least the two received quotes comprises automatically combining at least the two received quotes.

41. The method of claim 23, wherein displaying the combined quotes comprises automatically displaying the combined quotes to a user in real-time.

42. The method of claim 23, wherein displaying the combined quotes comprises automatically displaying the combined quotes within thirty minutes of receiving a quote from a second or subsequent market center for the common price and the common trading direction for at least the one security.

43. The method of claim 23, wherein receiving quotes comprises receiving quotes in a first computer system, and wherein displaying the combined quotes comprises automatically displaying the combined quotes to the user on the first computer system.

44. The method of claim 23, wherein receiving quotes comprises receiving quotes in a first computer system, wherein displaying the combined quotes comprises automatically displaying the combined quotes on a second computer system, and wherein the second computer system is coupled to the first computer system over a computer network.

45. The method of claim 23, wherein receiving quotes comprises receiving quotes in a first computer system, wherein displaying the combined quotes comprises automatically displaying the combined quotes on a second computer system, wherein the second computer system is coupled to the first computer system over a computer network, and wherein the computer network comprises the Internet.

46. The method of claim 23, wherein the received quotes further comprise a date and time at which the quote was received.

47. The method of claim 23, further comprising receiving user configuration data, wherein the user configuration data is used to alter the display of the combined quotes to the user.

48. The method of claim 23, further comprising receiving user configuration data, wherein the user configuration data is used to alter the display of the combined quotes to the user, and wherein the user configuration data comprises a list of columns of quote information to be displayed.

49. The method of claim 23, further comprising receiving user configuration data, wherein the user configuration data is used to alter the display of the combined quotes to the user, wherein the user configuration data comprises a list of columns of quote information to be displayed, and wherein the quote information comprises a market center identification, a bid price, an ask price, a quantity, a quote date, a quote time, or a combination thereof.

50. The method of claim 49, wherein the user configuration data is stored in a memory coupled to a first computer system or a second computer system, wherein the second computer system is coupled to the first computer system over a computer network.

51. A system configured to display securities information, comprising:
a first computer system coupled to a network, the first computer system, comprising:
a memory configured to receive user configuration data; and
a display system configured to display securities information in a securities display format, wherein the user configuration data affects the securities display format, and wherein the first computer system is configured to receive securities information from the network and to display securities information in the securities display format.

52. The system of claim 51, wherein the securities information is aggregated.

53. A system configured to receive information for securities, comprising:
a first computer system coupled to a network, the first computer system, comprising:
a memory configured to receive user configuration data; and
a display system configured to display securities information in a securities display format, wherein the user configuration data affects the securities display format, wherein the first computer system is configured to receive securities information from the network and to display securities information in the securities display format, and wherein the first computer system is further configured to receive order placement information for securities.

54. A carrier medium which stores program instructions, wherein the program instructions are computer-executable to implement a method for displaying information related to securities, the method comprising:
receiving quotes for at least one security;
combining two or more quotes from at least one market center, wherein the two or more quotes comprise a common price and a common trading direction for at least the one security;
transmitting the quotes to a user interface; and
displaying the combined quotes on the user interface.

55. The carrier medium of claim 54, wherein the carrier medium comprises a memory medium.

56. A carrier medium which stores program instructions, wherein the program instructions are computer-executable to implement a method for receiving order placement information for securities, the method comprising:
receiving quotes for at least one security;
combining two or more quotes from at least one market center, wherein the two or more quotes comprise a common price and a common trading direction for at least the one security;
transmitting the quotes to a user interface;
displaying the combined quotes on the user interface; and
receiving order placement information for securities from the user interface.

57. The carrier medium of claim 56, wherein the carrier medium comprises a memory medium.
